(19) United States
(12) Patent Application Publication
(10) Pub. No.: US 2026/0202705 A1
(43) Pub. Date: Jul. 16, 2026

(54) LIGHT ADJUSTMENT DEVICE

(71) Applicant: Japan Display Inc., Tokyo (JP)

(72) Inventors: Masato YOSHIDA, Tokyo (JP); Hirofumi OHIRA, Tokyo (JP)

(21) Appl. No.: 19/563,618

(22) Filed: Mar. 11, 2026

Related U.S. Application Data
(63) Continuation of application No. PCT/JP2024/024028, filed on Jul. 3, 2024.

(30) Foreign Application Priority Data
Sep. 14, 2023 (JP) 2023-149088

(51) Int. Cl. G02F 1/1347; G02F 1/1339; G02F 1/1343

(52) U.S. Cl. CPC G02F 1/1347; G02F 1/1339; G02F 1/134336

(57) ABSTRACT

A light adjustment device includes light adjustment panels each including a lower substrate provided with first drive electrodes, an upper substrate provided with second drive electrodes, a liquid crystal layer between the lower and upper substrates, a first sealing material extending along the liquid crystal layer and having an injection port, and a second sealing material sealing the injection port. When viewed in a first direction, the injection port overlaps neither a first straight line nor a second straight line. The first straight line extends in a second direction at a center in a third direction between the first drive electrodes at ends on one side and the other side in the third direction. The second straight line extends in the third direction at a center in the second direction between the second drive electrodes at ends on one side and the other side in the second direction.

### CROSS-REFERENCE TO RELATED APPLICATION

This application claims the benefit of priority from Japanese Patent Application No. 2023-149088 filed on Sep. 14, 2023 and International Patent Application No. PCT/JP2024/024028 filed on Jul. 3, 2024, the entire contents of which are incorporated herein by reference.

### BACKGROUND

### 1. Technical Field

What is disclosed herein relates to a light adjustment device.

### 2. Description of the Related Art

A light adjustment device includes, for example, a panel unit in which a plurality of light adjustment panels are stacked in the up-down direction (refer to Japanese Patent Application Laid-open Publication No. 2004-333567, for example). The light adjustment panel includes a lower substrate, an upper substrate, and a first sealing material and a liquid crystal layer that are sealed between the lower substrate and the upper substrate. In a case where the first seal material is provided with a liquid crystal injection port, the injection port is sealed with a second sealing material.

Various kinds of durability tests are performed before the light adjustment device is shipped. The durability tests include, for example, a test for examining corrosion of drive electrodes. The injection port of the first sealing material is sealed with the second sealing material; but in a high-load test in a high-humidity environment or the like, water vapor may enter between the second sealing material and the injection port, and water droplets may adhere to the drive electrodes due to condensation. The drive electrodes with water droplets may corrode and become open-circuited.

When the drive electrodes become open-circuited, the open-circuited drive electrodes become non-driven electrodes, and accordingly, part of a light-transmitting region of the light adjustment device may become dark.

### SUMMARY

According to an aspect, a light adjustment device includes a panel unit in which a plurality of light adjustment panels are stacked in a first direction. The light adjustment panels each include a lower substrate provided with a plurality of first drive electrodes, an upper substrate overlapping the lower substrate as viewed in the first direction and provided with a plurality of second drive electrodes, a liquid crystal layer positioned between the lower substrate and the upper substrate, a first sealing material extending along a perimeter of the liquid crystal layer between the lower substrate and the upper substrate and provided with an injection port, and a second sealing material sealing the injection port. The first sealing material continuously extends from one end to the other end, and a gap between the one end and the other end serves as the injection port. The first drive electrodes each extend in a second direction intersecting the first direction and are disposed at intervals in a third direction intersecting the first direction and the second direction. The second drive electrodes each extend in the third direction and are disposed at intervals in the second direction. A straight line extending in the second direction and positioned at a center in the third direction between a first drive electrode positioned at an end on one side in the third direction among the first drive electrodes and a first drive electrode positioned at an end on the other side in the third direction is defined as a first straight line. A straight line extending in the third direction and positioned at a center in the second direction between a second drive electrode positioned at an end on one side in the second direction among the second drive electrodes and a second drive electrode positioned at an end on the other side in the second direction is defined as a second straight line. When viewed in the first direction, the gap of the first sealing material does not overlap the first straight line or the second straight line.

### BRIEF DESCRIPTION OF THE DRAWINGS

FIG. 1 is a schematic diagram of a light adjustment device according to a first embodiment when viewed from the upper side;

FIG. 2 is a schematic diagram illustrating a section of the light adjustment device according to the first embodiment;

FIG. 3 is a schematic diagram of each light adjustment panel according to the first embodiment when viewed from the upper side;

FIG. 4 is a schematic diagram of a lower substrate included in the light adjustment panel in FIG. 3 when viewed from the upper side;

FIG. 5 is a schematic diagram of an upper substrate included in the light adjustment panel in FIG. 3 when viewed from the upper side;

FIG. 6 is a schematic diagram illustrating a state in which the lower substrate in FIG. 4 and the upper substrate in FIG. 5 are overlaid;

FIG. 7 is a schematic diagram illustrating the uppermost light adjustment panel in a panel unit according to the first embodiment;

FIG. 8 is a schematic diagram illustrating the second uppermost light adjustment panel in the panel unit according to the first embodiment;

FIG. 9 is a schematic diagram illustrating the third uppermost light adjustment panel in the panel unit according to the first embodiment;

FIG. 10 is a schematic diagram illustrating the fourth uppermost light adjustment panel in the panel unit according to the first embodiment;

FIG. 11 is a schematic diagram comparing four light adjustment panels included in a panel unit according to a first aspect and four light adjustment panels included in a panel unit according to a second aspect;

FIG. 12 is a schematic diagram of a light adjustment device according to a second embodiment when viewed from the upper side;

FIG. 13 is a schematic diagram illustrating the uppermost light adjustment panel in a panel unit according to the second embodiment;

FIG. 14 is a schematic diagram of a lower substrate included in the light adjustment panel in FIG. 13 when viewed from the upper side;

FIG. 15 is a schematic diagram of an upper substrate included in the light adjustment panel in FIG. 13 when viewed from the upper side;

FIG. 16 is a schematic diagram illustrating a state in which the lower substrate in FIG. 14 and the upper substrate in FIG. 15 are overlaid;

FIG. 17 is a schematic diagram illustrating the uppermost light adjustment panel in the panel unit according to the second embodiment;

FIG. 18 is a schematic diagram illustrating the second uppermost light adjustment panel in the panel unit according to the second embodiment;

FIG. 19 is a schematic diagram illustrating the third uppermost light adjustment panel in the panel unit according to the second embodiment; and

FIG. 20 is a schematic diagram illustrating the fourth uppermost light adjustment panel in the panel unit according to the second embodiment.

### DETAILED DESCRIPTION

Aspects (embodiments) of the present disclosure will be described below in detail with reference to the accompanying drawings. Contents described below in the embodiments do not limit the present disclosure. Components described below include those that could be easily thought of by the skilled person in the art and those identical in effect. Components described below may be combined as appropriate.

What is disclosed herein is merely exemplary, and any modification that could be easily thought of by the skilled person in the art as appropriate without departing from the gist of the disclosure is contained in the scope of the present disclosure. For clearer description, the drawings are schematically illustrated for the width, thickness, shape, and the like of each component as compared to an actual aspect in some cases, but the drawings are merely exemplary and do not limit interpretation of the present disclosure. In the present specification and drawings, any element same as that already described with reference to an already described drawing is denoted by the same reference sign, and detailed description thereof is omitted as appropriate in some cases.

In an XYZ coordinate system illustrated in the drawings, an X direction is the right-left direction, and an X1 side is opposite an X2 side. The X1 side is also referred to as a left side, and the X2 side is also referred to as a right side. A Y direction is the front-back direction, and a Y1 side is opposite a Y2 side. The Y1 side is also referred to as a front side, and the Y2 side is also referred to as a back side. A Z direction is the up-down direction (stacking direction). A Z1 side is opposite a Z2 side. The Z1 side is also referred to as an upper side, and the Z2 side is also referred to as a lower side. The Z direction is also referred to as a first direction. The Z2 side is also referred to as one side in the first direction, and the Z1 side is also referred to as the other side in the first direction. The X direction is also referred to as a second direction. The X1 side is also referred to as one side in the second direction, and the X2 side is also referred to as the other side in the second direction. The Y direction is also referred to as the second direction. The Y1 side is also referred to as one side in the third direction, and the Y2 side is also referred to as the other side in the third direction.

### First Embodiment

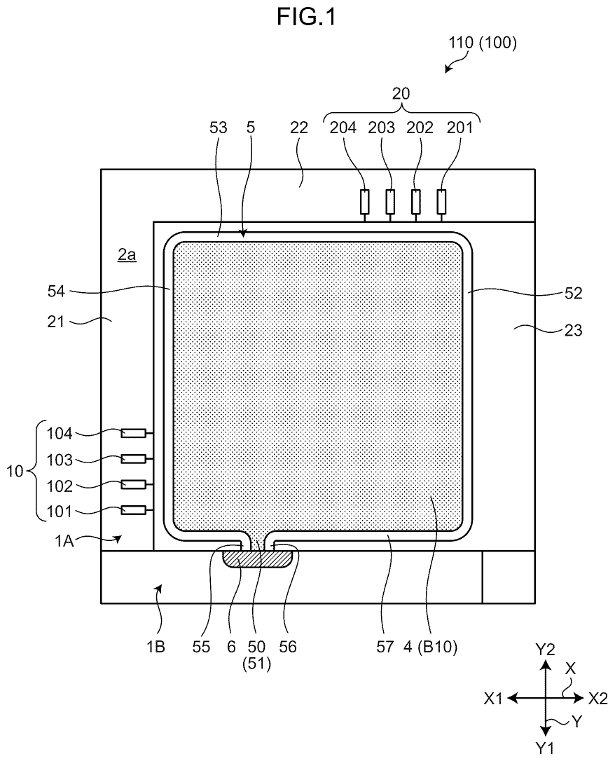

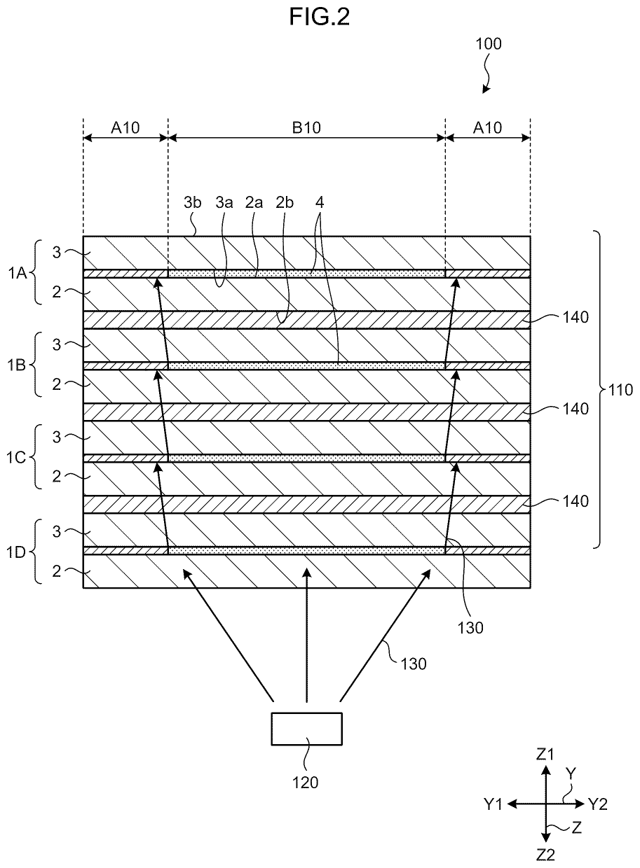

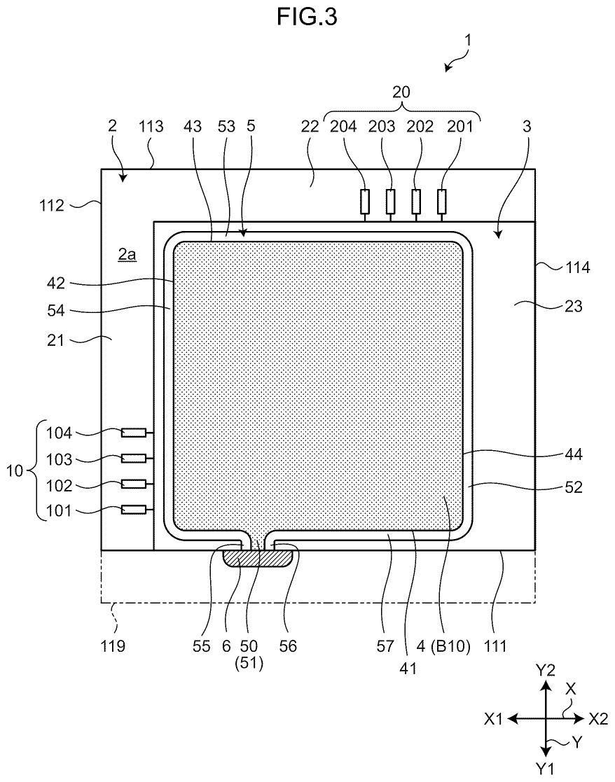

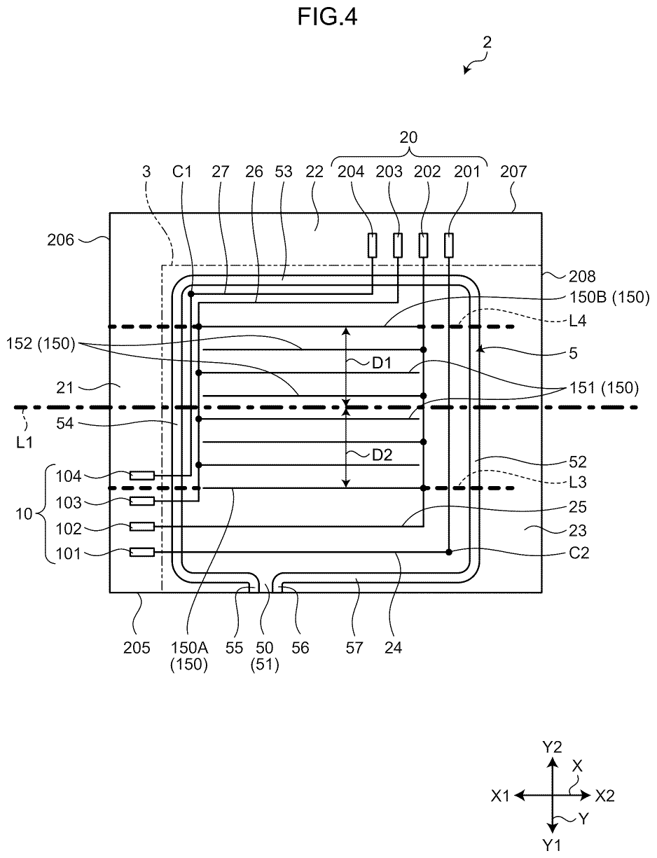

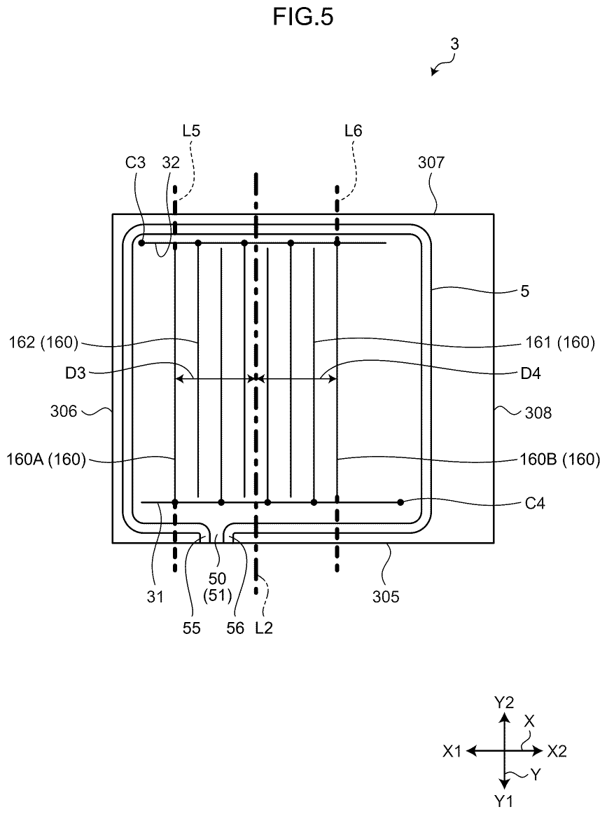

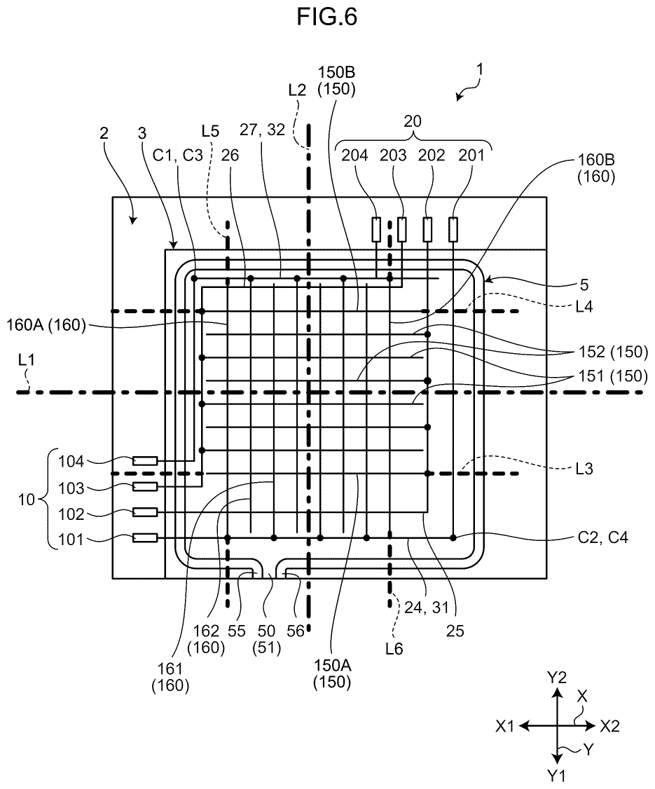

A light adjustment device according to a first embodiment will be described below. FIG. 1 is a schematic diagram of the light adjustment device according to the first embodiment when viewed from the upper side. FIG. 2 is a schematic diagram illustrating a section of the light adjustment device according to the first embodiment. FIG. 3 is a schematic diagram of each light adjustment panel according to the first embodiment when viewed from the upper side. FIG. 4 is a schematic diagram of a lower substrate included in the light adjustment panel in FIG. 3 when viewed from the upper side. FIG. 5 is a schematic diagram of an upper substrate included in the light adjustment panel in FIG. 3 when viewed from the upper side. FIG. 6 is a schematic diagram illustrating a state in which the lower substrate in FIG. 4 and the upper substrate in FIG. 5 are overlaid.

As illustrated in FIGS. 1 and 2, a light adjustment device 100 according to the first embodiment includes a panel unit 110 and a light source 120. In the light adjustment device according to the embodiment, light adjustment panels (liquid crystal cells) for p-wave polarization and light adjustment panels (liquid crystal cells) for s-wave polarization are stacked and combined. Specifically, a plurality of sets are stacked, each set including a light adjustment panel for p-wave polarization and a light adjustment panel for s-wave polarization, which is obtained by rotating the light adjustment panel for p-wave polarization by 90°.

As illustrated in FIG. 1, in the present embodiment, the panel unit 110 has a square perimeter when viewed in the Z direction. In the present disclosure, the shape of the panel unit 110 is not limited to a square, and various shapes such as polygons including an octagon and a hexagon to be described later are applicable.

As illustrated in FIG. 2, the panel unit 110 is formed by stacking a plurality of light adjustment panels 1 in the Z direction (first direction). In the present embodiment, a plurality (in the embodiment, four) of light adjustment panels 1 are stacked. Specifically, the four light adjustment panels 1 are, sequentially from the upper side, a light adjustment panel 1A, a light adjustment panel 1B, a light adjustment panel 1C, and a light adjustment panel 1D. Each of the light adjustment panels 1A, 1B, 1C, and 1D includes a lower substrate 2 and an upper substrate 3. A front surface 2a of the lower substrate 2 and a front surface 3a of the upper substrate 3 face each other with a liquid crystal layer 4 interposed therebetween. A back surface 2b of the lower substrate 2 is a surface opposite the front surface 2a. A back surface 3b of the upper substrate 3 is a surface opposite the front surface 3a. The light adjustment panels 1A, 1B, 1C, and 1D are bonded to each other through a light-transmitting bonding agent 140. Accordingly, all light adjustment panels adjacent to each other in the Z direction are bonded to each other through the light-transmitting bonding agent 140. The number of light adjustment panels 1 included in the light adjustment device 100 is not limited to four but may be two or more. The light source 120 is disposed on the Z2 side relative to the panel unit 110. Light 130 emitted from the light source 120 is incident from below the panel unit 110, travels toward the Z1 side through a light-transmitting region B10 from the light adjustment panel 1D to the light adjustment panel 1A, and exits from the uppermost light adjustment panel 1A.

As illustrated in FIG. 3, each light adjustment panel 1 includes the lower substrate 2, the upper substrate 3, the liquid crystal layer 4, a first sealing material 5, and a second sealing material 6. As illustrated in FIG. 3, each light adjustment panel 1 is a rectangle that is long in the X direction when viewed in the Z direction. In other words, the perimeter of each light adjustment panel 1 includes an edge 111, an edge 112, an edge 113, and an edge 114; and a rectangle that is long in the X direction is formed with the edges 111, 112, 113, and 114. A square is formed with a dashed and double-dotted line 119 on the Y1 side and the edges 112, 113, and 114. The edge 111 is positioned on the Y2 side relative to the dashed and double-dotted line 119.

As illustrated in FIGS. 2 and 3, each light adjustment panel 1 is provided with the liquid crystal layer 4. A region in which the liquid crystal layer 4 is provided is the light-transmitting region (effective region) B10. A region outside the light-transmitting region (effective region) B10 is a light-shielding region (frame region) A10. As illustrated in FIG. 3, the liquid crystal layer 4 is substantially square when viewed in the Z direction. Specifically, the liquid crystal layer 4 has sides 41, 42, 43, and 44.

As illustrated in FIG. 3, the first sealing material 5 is provided along the perimeter (sides 41, 42, 43, and 44) of the liquid crystal layer 4. The first sealing material 5 forms a square shape (frame) when viewed in the Z direction, which has sides 57, 52, 53, and 54. An injection port 50 is provided in the side 57. Specifically, the side 57 is provided with bent portions 55 and 56, and a space between the bent portion 55 and the bent portion 56 serves as the injection port 50. In other words, the first sealing material 5 continuously extends from the bent portion 55 at one end to the bent portion 56 at the other end, and a gap 51 between the one end and the other end serves as the injection port 50. Liquid crystal is injected into the frame formed with the first sealing material 5 through the injection port 50. Distal ends of the bent portion 55 and the bent portion 56 on the Y1 side are joined to each other by applying the second sealing material 6 thereto. The second sealing material 6 is cured by, for example, applying and drying UV curable resin. The second sealing material 6 seals the injection port 50 and prevents the liquid crystal from flowing out.

As illustrated in FIGS. 4 and 6, end portions 21, 22, and 23 are provided at the lower substrate 2 of each light adjustment panel 1. The end portion 21 is positioned on the X1 side relative to the liquid crystal layer 4, the end portion 22 is positioned on the Y2 side relative to the liquid crystal layer 4, and the end portion 23 is positioned on the X2 side relative to the liquid crystal layer 4. The lower substrate 2 has four sides 205, 206, 207, and 208.

As illustrated in FIG. 4, a first terminal group 10 is provided at the end portion 21. A second terminal group 20 is provided at the end portion 22. The first terminal group 10 includes a first terminal 101, a second terminal 102, a third terminal 103, and a fourth terminal 104. The first terminal 101, the second terminal 102, the third terminal 103, and the fourth terminal 104 are disposed in the Y direction. The second terminal group 20 includes a fifth terminal 201, a sixth terminal 202, a seventh terminal 203, and an eighth terminal 204. The fifth terminal 201, the sixth terminal 202, the seventh terminal 203, and the eighth terminal 204 are disposed in the X direction.

As illustrated in FIG. 4, the first terminal 101 and the fifth terminal 201 are coupled to each other through a wiring line 24. A coupling portion C2 is provided in the wiring line 24. The second terminal 102 and the sixth terminal 202 are coupled to each other through a wiring line 25. The third terminal 103 and the seventh terminal 203 are coupled to each other through a wiring line 26. The fourth terminal 104 and the eighth terminal 204 are coupled to each other through a wiring line 27. A coupling portion C1 is provided in the wiring line 27. A plurality of first drive electrodes 150 are provided on the lower substrate 2. Among the first drive electrodes 150, an electrode positioned at the farthest end on the Y1 side is a first drive electrode 150A, and an electrode positioned at the farthest end on the Y2 side is a first drive electrode 150B.

A straight line positioned at the center between the first drive electrode 150A and the first drive electrode 150B is defined as a first straight line L1. Specifically, the first straight line L1 extends in the X direction. A distance D1 between the first straight line L1 and the first drive electrode 150B is equal to a distance D2 between the first straight line L1 and the first drive electrode 150A. The first drive electrodes 150 include first drive electrodes 151 and 152. The first drive electrodes 151 are coupled to the wiring line 26. The first drive electrodes 152 are coupled to the wiring line 25. The first drive electrodes 151 and 152 extend in the X direction. The first drive electrodes 151 and 152 are alternately arranged in the Y direction. A straight line overlapping the first drive electrode 150A is defined as a third straight line L3, and a straight line overlapping the first drive electrode 150B is defined as a fourth straight line L4. The third straight line L3 and the fourth straight line L4 extend in the X direction.

As illustrated in FIGS. 5 and 6, the upper substrate 3 has sides 305, 306, 307, and 308. A wiring line 31 and a wiring line 32 extend in the X direction. A coupling portion C4 is provided in the wiring line 31. A coupling portion C3 is provided in the wiring line 32. The coupling portion C4 is coupled to the coupling portion C2 through a non-illustrated conductive pillar. The coupling portion C3 is coupled to the coupling portion C1 through a non-illustrated conductive pillar. A plurality of second drive electrodes 160 are provided on the upper substrate 3. Among the second drive electrodes 160, an electrode positioned at the farthest end on the X1 side is a second drive electrode 160A, and an electrode positioned at the farthest end on the X2 side is a second drive electrode 160B.

A straight line positioned at the center between the second drive electrode 160A and the second drive electrode 160B is defined as a second straight line L2. Specifically, the second straight line L2 extends in the Y direction. A distance D3 between the second straight line L2 and the second drive electrode 160A is equal to a distance D4 between the second straight line L2 and the second drive electrode 160B. The second drive electrodes 160 include second drive electrodes 161 and 162. The second drive electrodes 161 are coupled to the wiring line 31. The second drive electrodes 162 are coupled to the wiring line 32. The second drive electrodes 161 and 162 extend in the Y direction. The second drive electrodes 161 and 162 are alternately arranged in the X direction. A straight line overlapping the second drive electrode 160A is defined as a fifth straight line L5, and a straight line overlapping the second drive electrode 160B is defined as a sixth straight line L6. The fifth straight line L5 and the sixth straight line L6 extend in the Y direction.

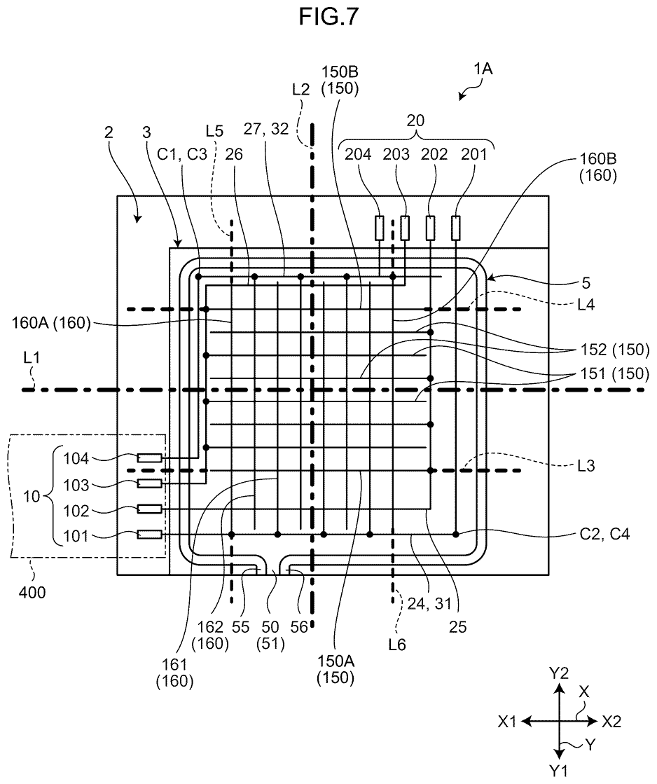

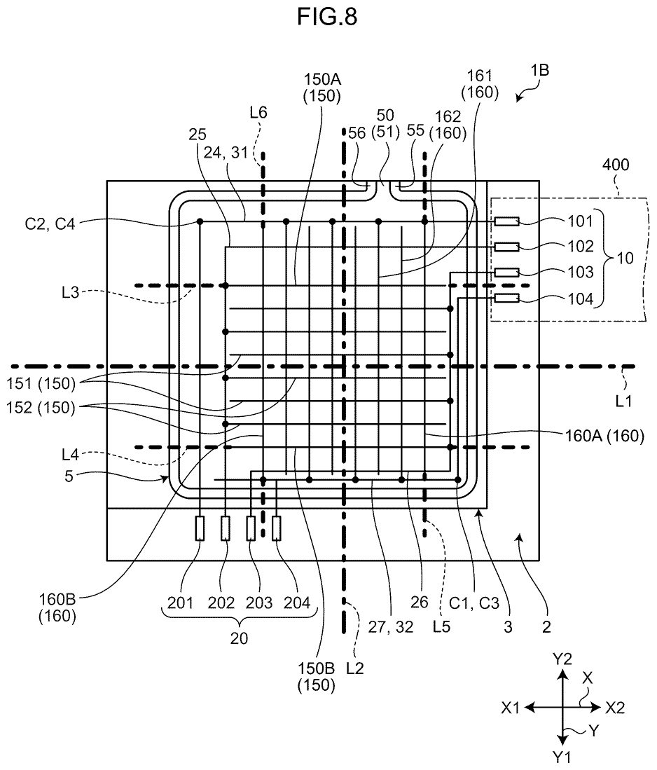

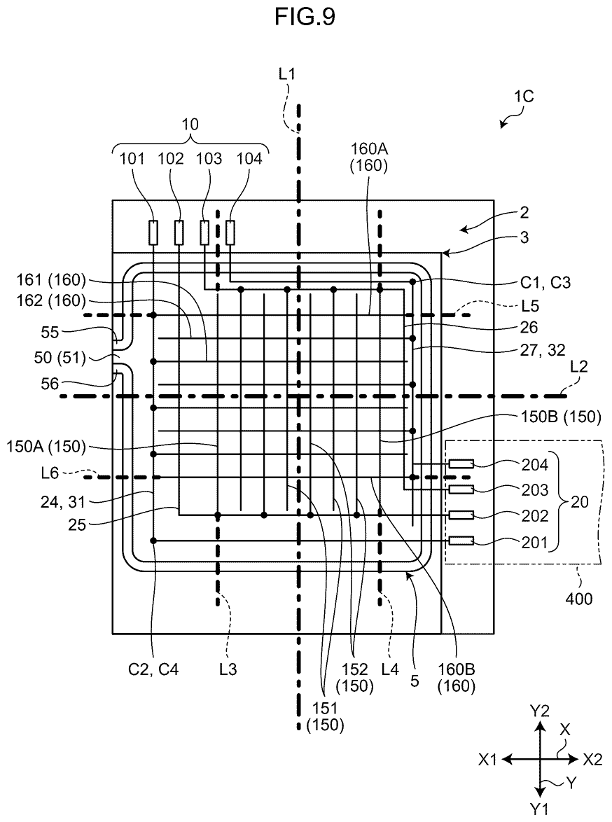

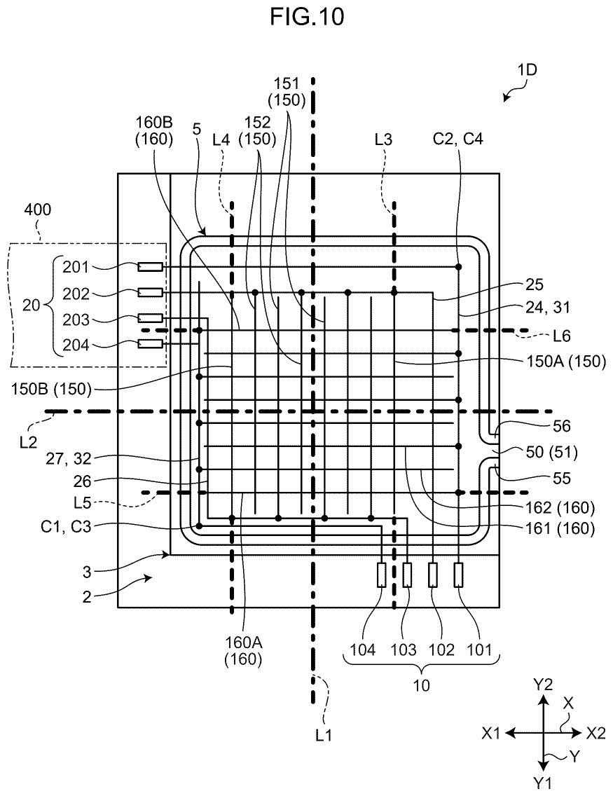

The following describes the orientations of the light adjustment panel 1A, the light adjustment panel 1B, the light adjustment panel 1C, and the light adjustment panel 1D included in the panel unit 110 with reference to FIGS. 7 to 10. FIG. 7 is a schematic diagram illustrating the uppermost light adjustment panel in the panel unit according to the first embodiment. FIG. 8 is a schematic diagram illustrating the second uppermost light adjustment panel in the panel unit according to the first embodiment. FIG. 9 is a schematic diagram illustrating the third uppermost light adjustment panel in the panel unit according to the first embodiment. FIG. 10 is a schematic diagram illustrating the fourth uppermost light adjustment panel in the panel unit according to the first embodiment.

As described above, the four light adjustment panels 1 are the light adjustment panel 1A, the light adjustment panel 1B, the light adjustment panel 1C, and the light adjustment panel 1D stacked sequentially from the upper side. In the light adjustment panel 1A, the injection port 50 faces the Y1 side. The light adjustment panel 1B is in a state obtained by rotating the light adjustment panel 1A by 180° about an intersection point of the first straight line L1 and the second straight line L2. In the light adjustment panel 1B, the injection port 50 faces the Y2 side. The light adjustment panel 1C is in a state obtained by rotating the light adjustment panel 1A clockwise by 90° about the intersection point of the first straight line L1 and the second straight line L2. In the light adjustment panel 1C, the injection port 50 faces the X1 side. The light adjustment panel 1D is in a state obtained by rotating the light adjustment panel 1C by 180° about the intersection point of the first straight line L1 and the second straight line L2. In the light adjustment panel 1D, the injection port 50 faces the X2 side.

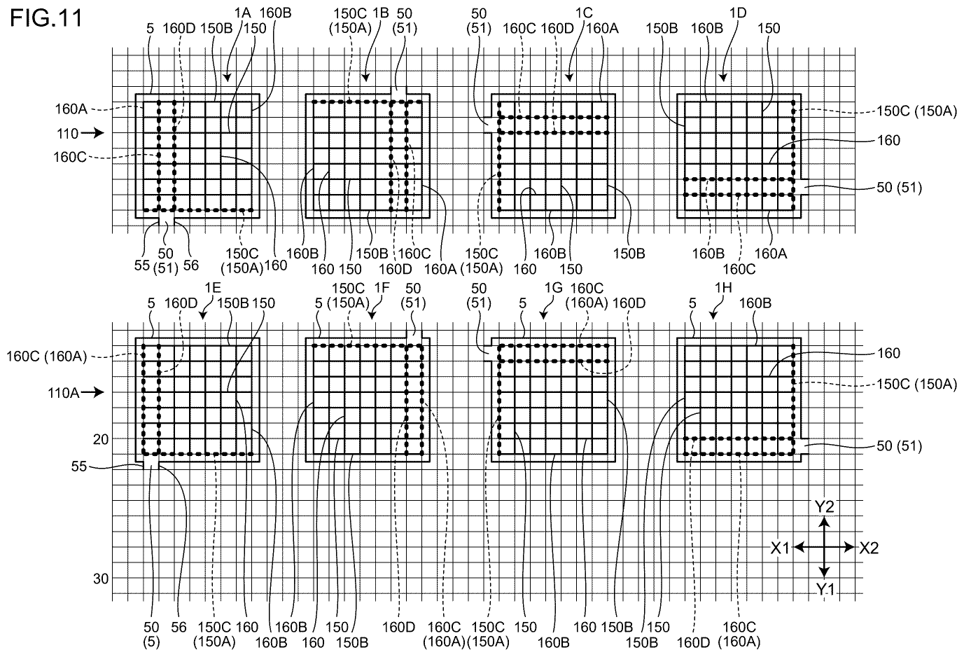

Next, an overlapping state of drive electrodes that may be broken and become open-circuited will be described below in comparison between the light adjustment panels included in the panel unit 110 according to a first aspect and the light adjustment panels included in a panel unit 110A according to a second aspect. FIG. 11 is a schematic diagram comparing the four light adjustment panels included in the panel unit according to the first aspect, and the four light adjustment panels included in the panel unit according to the second aspect.

Various kinds of durability tests are performed before the light adjustment device 100 is shipped. The durability tests include, for example, a test for examining corrosion of drive electrodes. Specifically, the injection port 50 is sealed with the second sealing material 6 as described above; but in a high-load test in a high-humidity environment, water vapor may enter between the second sealing material 6 and the injection port 50 and may condense such that water droplets adhere to the drive electrodes. The drive electrodes to which water droplets are likely to adhere are, for example, drive electrodes illustrated with bold dashed lines in FIG. 11. The drive electrodes with water droplets are highly likely to corrode and become open-circuited. The drive electrodes to which water droplets are likely to adhere and that are highly likely to become open-circuited will be described below with reference to FIG. 11. In FIG. 11, the upper part illustrates the four light adjustment panels included in the panel unit 110 according to the first aspect, and the lower part illustrates the four light adjustment panels included in the panel unit 110A according to the second aspect. The difference between the panel unit 110 and the panel unit 110A is the position of the injection port 50. In other words, the injection port 50 of the panel unit 110A is positioned at an end portion on the X1 side. Specifically, as illustrated in the lower part of FIG. 11, the injection port 50 faces second drive electrodes 160C and 160D positioned at the end portion on the X1 side among the second drive electrodes 160. However, the injection port 50 of the panel unit 110 is positioned on the X2 side relative to the injection port 50 of the panel unit 110A. Specifically, as illustrated in the upper part of FIG. 11, the injection port 50 faces second drive electrodes 160C and 160D that are second and third ones from an end on the X1 side among the second drive electrodes 160.

In the light adjustment panel 1A positioned leftmost in the panel unit 110 according to the first aspect, among the first drive electrodes 150, a drive electrode that is most likely to become open-circuited due to a high-load test is a first drive electrode 150C disposed at a position closest to the injection port 50. The first drive electrode 150C is illustrated with a bold dashed line. In the first embodiment, the first drive electrode 150C is identical to the first drive electrode 150A. Among the second drive electrodes 160, drive electrodes that are most likely to become open-circuited due to a high-load test are the second drive electrodes 160C and 160D disposed at positions closest to the injection port 50. The second drive electrodes 160C and 160D are illustrated with bold dashed lines. Hereinafter, in the light adjustment panels 1B, 1C, and 1D, the first drive electrode 150C and the second drive electrodes 160C and 160D are disposed in the manner illustrated in the upper part of FIG. 11.

The first drive electrode 150B of the light adjustment panel 1B, the second drive electrode 160B of the light adjustment panel 1C, and the second drive electrode 160A of the light adjustment panel 1D are disposed on the lower side (Z2 side) relative to the first drive electrode 150C of the light adjustment panel 1A so as to overlap the first drive electrode 150C of the light adjustment panel 1A. Thus, even if the first drive electrode 150C of the light adjustment panel 1A becomes open-circuited in a high-load test, the first drive electrode 150B, the second drive electrode 160B, and the second drive electrode 160A in the other light adjustment panels remain in a closed-circuit state.

The first drive electrode 150B of the light adjustment panel 1A, the second drive electrode 160A of the light adjustment panel 1C, and the second drive electrode 160B of the light adjustment panel 1D are disposed so as to overlap the first drive electrode 150C in the light adjustment panel 1B in the Z direction. Thus, even if the first drive electrode 150C of the light adjustment panel 1B becomes open-circuited in a high-load test, the first drive electrode 150B, the second drive electrode 160A, and the second drive electrode 160B in the other light adjustment panels remain in a closed-circuit state.

The first drive electrode 150B, the second drive electrode 160A, and the second drive electrode 160B in the other light adjustment panels are disposed so as to overlap the first drive electrode 150C in the light adjustment panel 1C in the Z direction. The first drive electrode 150B, the second drive electrode 160A, and the second drive electrode 160B in the other light adjustment panels are disposed so as to overlap the first drive electrode 150C in the light adjustment panel 1D in the Z direction. In this manner, in the first aspect, even if the first drive electrode 150C of one light adjustment panel becomes open-circuited, the first drive electrode 150B, the second drive electrode 160A, and the second drive electrode 160B of the other three light adjustment panels remain in a closed-circuit state. Similarly, even if the second drive electrodes 160C and 160D of one light adjustment panel become open-circuited, drive electrodes of the other three light adjustment panels that overlap the second drive electrodes 160C and 160D as viewed in the Z direction remain in a closed-circuit state.

The panel unit 110A according to the second aspect will be described below. In a light adjustment panel 1E positioned leftmost in the panel unit 110A, among the first drive electrodes 150, a drive electrode that is most likely to become open-circuited due to a high-load test is the first drive electrode 150C disposed at a position closest to the injection port 50, as in the panel unit 110. The first drive electrode 150C is illustrated with a bold dashed line. In the first embodiment, the first drive electrode 150C is identical to the first drive electrode 150A. Among the second drive electrodes 160, drive electrodes that are most likely to become open-circuited due to a high-load test are the second drive electrodes 160C and 160D disposed at positions closest to the injection port 50. The second drive electrodes 160C and 160D of the panel unit 110A are positioned on the X1 side relative to the second drive electrodes 160C and 160D of the panel unit 110. Specifically, the second drive electrode 160C is positioned farthest on the X1 side among the second drive electrodes 160, and the second drive electrode 160D is adjacent to the second drive electrode 160C on the X2 side. The second drive electrodes 1600 and 160D are illustrated with bold dashed lines. Hereinafter, in light adjustment panels 1F, 1G, 1H, the first drive electrode 150C and the second drive electrodes 160C and 160D are disposed in the manner illustrated in the lower part of FIG. 11.

The first drive electrode 150B of the light adjustment panel 1F, the second drive electrode 160B of the light adjustment panel 1G, and the second drive electrode 160A (second drive electrode 160C) of the light adjustment panel 1H are disposed on the lower side (Z2 side) relative to the first drive electrode 150C of the light adjustment panel 1E so as to overlap the first drive electrode 150C of the light adjustment panel 1E. Thus, even if the first drive electrode 150C of the light adjustment panel 1E becomes open-circuited in a high-load test, the first drive electrode 150B and the second drive electrode 160B in the other light adjustment panels remain in a closed-circuit state. However, since the second drive electrode 160A (second drive electrode 160C) of the light adjustment panel 1H is in an open-circuit state, the number of electrodes in a closed-circuit state is smaller by one than in the panel unit 110. Specifically, when the first drive electrode 150C of one light adjustment panel becomes open-circuited, the first drive electrode 150B and the second drive electrode 160B of other two light adjustment panels remain in a closed-circuit state.

The first drive electrode 150B of the light adjustment panel 1E, the second drive electrode 160A (second drive electrode 160C) of the light adjustment panel 1G, and the second drive electrode 160B of the light adjustment panel 1H are disposed so as to overlap the first drive electrode 150C in the light adjustment panel 1F in the Z direction. Thus, even if the first drive electrode 150C of the light adjustment panel 1F becomes open-circuited in a high-load test, the first drive electrode 150B and the second drive electrode 160B of the other light adjustment panels remain in a closed-circuit state. However, since the second drive electrode 160A (second drive electrode 160C) of the light adjustment panel 1G is in an open-circuit state, the number of electrodes in a closed-circuit state is smaller by one than in the panel unit 110. In addition, the first drive electrode 150B and the second drive electrode 160B of the other light adjustment panels are disposed so as to overlap the first drive electrode 150C in the light adjustment panel 1G in the Z direction. Similarly, the first drive electrode 150B and the second drive electrode 160B of the other light adjustment panels are disposed so as to overlap the first drive electrode 150C in the light adjustment panel 1H in the Z direction. In this manner, in the second aspect, when the first drive electrode 150C of one light adjustment panel becomes open-circuited, the first drive electrode 150B and the second drive electrode 160B of other two light adjustment panels remain in a closed-circuit state. Similarly, even if the second drive electrode 160C of one light adjustment panel becomes open-circuited, drive electrodes (the first drive electrode 150B and the second drive electrode 160B) of other two light adjustment panels that overlap the second drive electrode 160° C. as viewed in the Z direction remain in a closed-circuit state.

As described above, the light adjustment device 100 includes the panel unit 110, and the panel unit 110 includes a plurality of light adjustment panels 1. Each light adjustment panel 1 includes the lower substrate 2, the upper substrate 3, the liquid crystal layer 4, and the second sealing material 6 sealing the first sealing material 5 and the injection port 50. The gap 51 between one end and the other end of the first sealing material 5 serves as the injection port 50. The first drive electrodes 150 extend in the X direction, and the second drive electrodes 160 extend in the Y direction. A straight line positioned at the center between the first drive electrode 150A and the first drive electrode 150B is defined as the first straight line L1. A straight line positioned at the center between the second drive electrode 160A and the second drive electrode 160B is defined as the second straight line L2. When viewed in the Z direction, the gap 51 of the first sealing material 5 does not overlap the first straight line L1 or the second straight line L2.

As described above, in a high-load test in a high-humidity environment or the like, water vapor may enter between the second sealing material and the injection port and may condense, so that water droplets adhere to drive electrodes. The drive electrodes with water droplets may corrode and become open-circuited. When the drive electrodes become open-circuited, the open-circuited drive electrodes become non-driven electrodes, and accordingly, part of the light-transmitting region of the light adjustment device may become dark.

If a state is assumed in which the gap 51 of the first sealing material 5 overlaps the first straight line L1, a drive electrode close to the first straight line L1 among the drive electrodes may become open-circuited. The panel unit 110 is formed by stacking a plurality (in the present embodiment, four) of light adjustment panels 1 in the Z direction, each being rotated by 90° about the intersection point of the first straight line L1 and the second straight line L2. Thus, when the panel unit 110 is viewed from the upper side, open-circuited drive electrodes are concentrated and disposed in a central portion of the light-transmitting region. Specifically, for example, if it is assumed that two first drive electrodes 150 with the first straight line L1 interposed therebetween become open-circuited, two first drive electrodes 150 extending in the X direction become open-circuited in the uppermost light adjustment panel 1A and the second uppermost light adjustment panel 1B, and two first drive electrodes 150 extending in the Y direction become open-circuited in the third uppermost light adjustment panel 1C and the fourth uppermost light adjustment panel 1D. Thus, a square dark region may occur in the central portion of the light-transmitting region.

However, in the present embodiment, the gap 51 of the first sealing material 5 does not overlap the first straight line L1 or the second straight line L2. Thus, if it is assumed that two first drive electrodes 150 in one light adjustment panel 1 become open-circuited, the open-circuited drive electrodes are not concentrated in a specific portion even in the configuration in which the four light adjustment panels 1 are stacked. Consequently, darkening of part of the light-transmitting region of the light adjustment device 100 is inhibited.

If a straight line overlapping the second drive electrode 160A is defined as the fifth straight line L5 and a straight line overlapping the second drive electrode 160B is defined as the sixth straight line L6, the gap 51 of the first sealing material 5 is provided at a position between the fifth straight line L5 and the sixth straight line L6 and not overlapping the fifth straight line L5 or the sixth straight line L6 when viewed in the Z direction.

As described above in the first aspect, even if a drive electrode of one light adjustment panel becomes open-circuited, drive electrodes of the other three light adjustment panels remain in a closed-circuit state. In other words, even if one drive electrode becomes open-circuited, three drive electrodes that overlap the one drive electrode as viewed in the Z direction remain in a closed-circuit state.

However, in the second aspect in which the gap 51 overlaps the fifth straight line L5 or the sixth straight line L6, if a drive electrode of one light adjustment panel becomes open-circuited, drive electrodes of other two light adjustment panels that overlap the drive electrode of the one light adjustment panel as viewed in the Z direction remain in a closed-circuit state. In other words, the number of drive electrodes remaining in a closed-circuit state and overlapping in the Z direction in the first aspect is larger than in the second aspect. Thus, the first aspect further inhibits darkening of part of the light-transmitting region of the light adjustment device 100.

If a straight line overlapping the first drive electrode 150A is defined as the third straight line L3 and a straight line overlapping the first drive electrode 150B is defined as the fourth straight line L4, the gap 51 of the first sealing material 5 is provided at a position between the third straight line L3 and the fourth straight line L4 and not overlapping the third straight line L3 or the fourth straight line L4 when viewed in the Z direction.

This is assumed for, for example, a configuration in which the injection port 50 is formed in the side 52 or the side 54 of the first sealing material 5 in FIG. 3. Specifically, as an aspect of the injection port 50 provided in the side 52 or the side 54 of the first sealing material 5, the gap 51 is disposed at a position between the third straight line L3 and the fourth straight line L4 and not overlapping the third straight line L3 or the fourth straight line L4.

In this case as well, as in the above-described comparison between the first and second aspects, if a drive electrode of one light adjustment panel becomes open-circuited, a larger number of drive electrodes overlapping the open-circuited drive electrode in the Z direction remain in a closed-circuit state, whereby, darkening of part of the light-transmitting region of the light adjustment device 100 is further inhibited.

The panel unit 110 and the light adjustment panels 1 each have a polygonal (quadrangular) perimeter when viewed in the Z direction.

Accordingly, the light adjustment panels 1A, 1B, 1C, and 1D are quadrangular; and thus, when the light adjustment panels 1 are rotated by 90° or 180° and stacked, it is only necessary to align the sides of the respective light adjustment panels 1 with each other when viewed in the Z direction, which facilitates stacking work.

### Second Embodiment

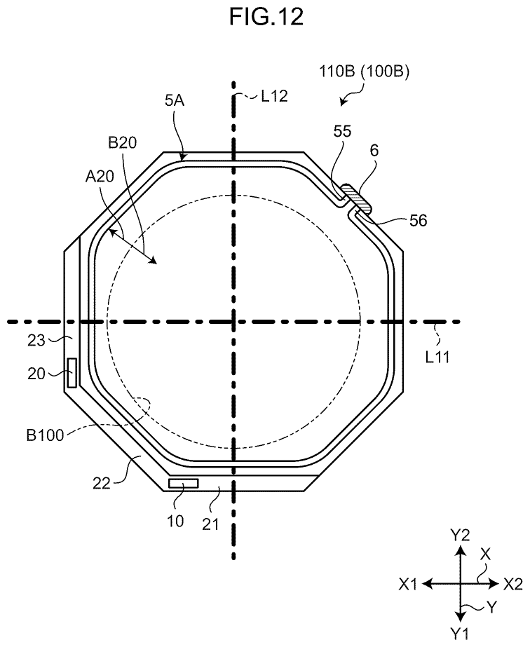

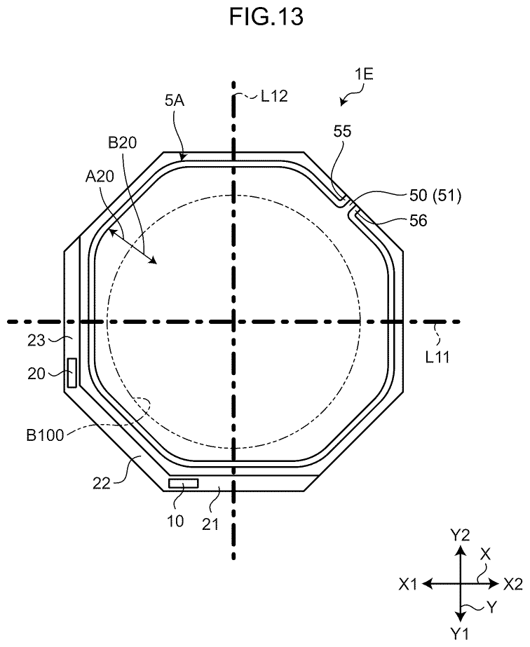

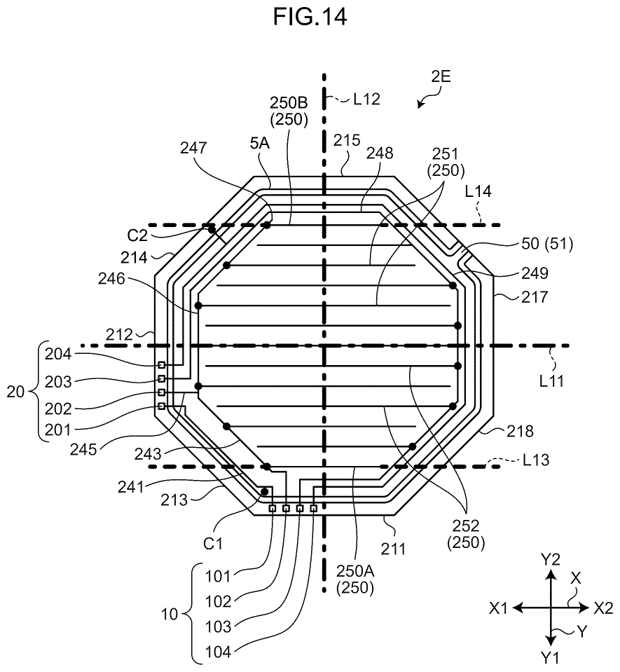

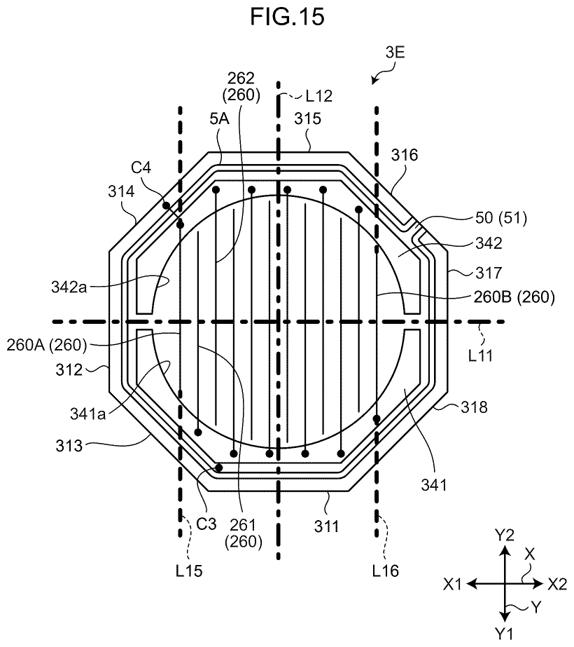

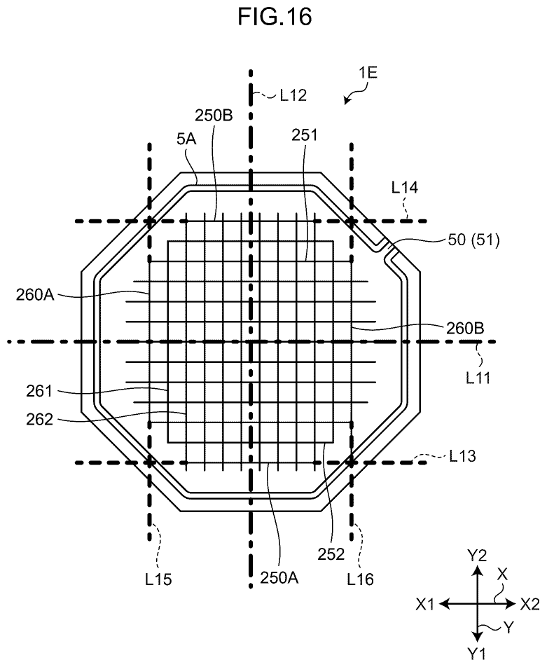

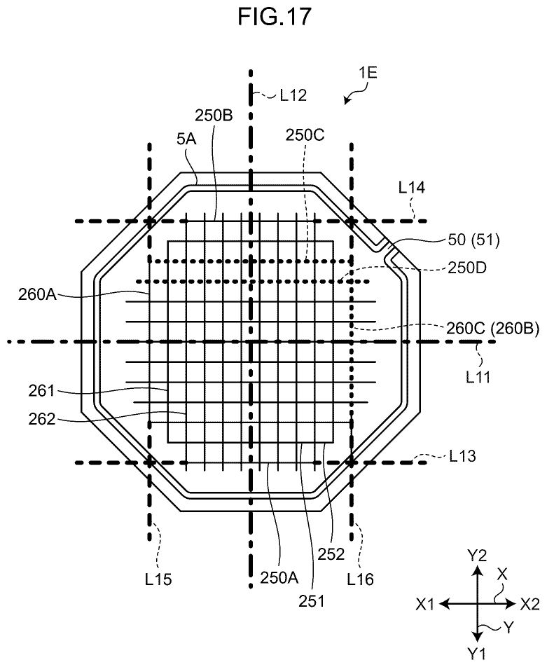

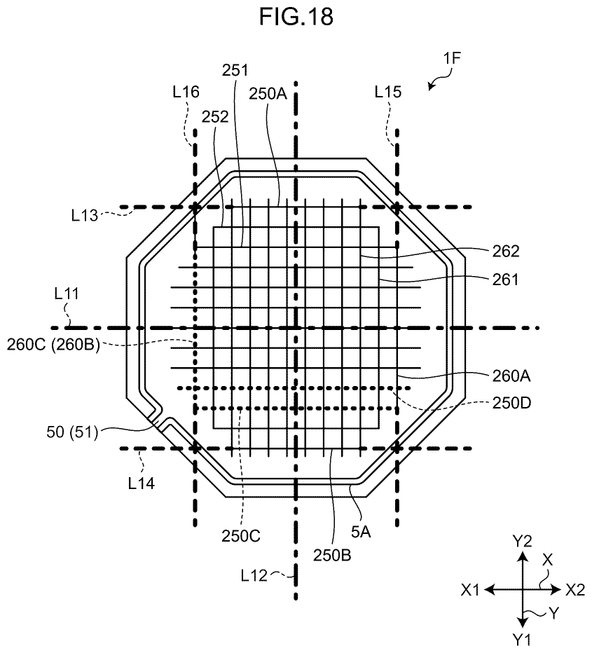

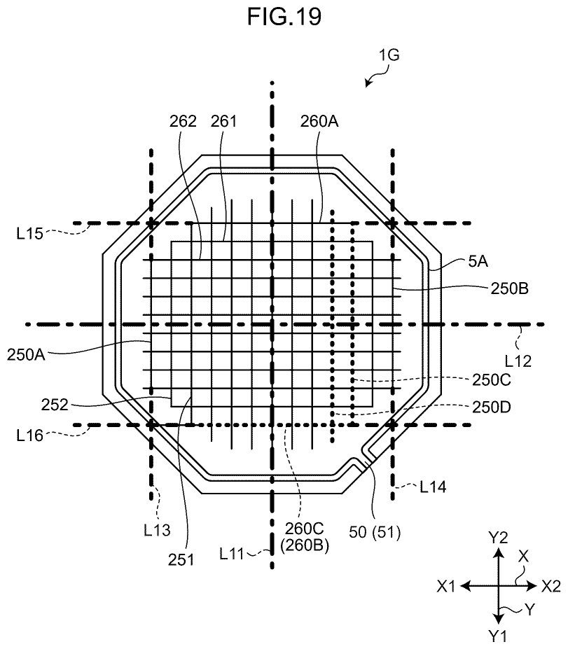

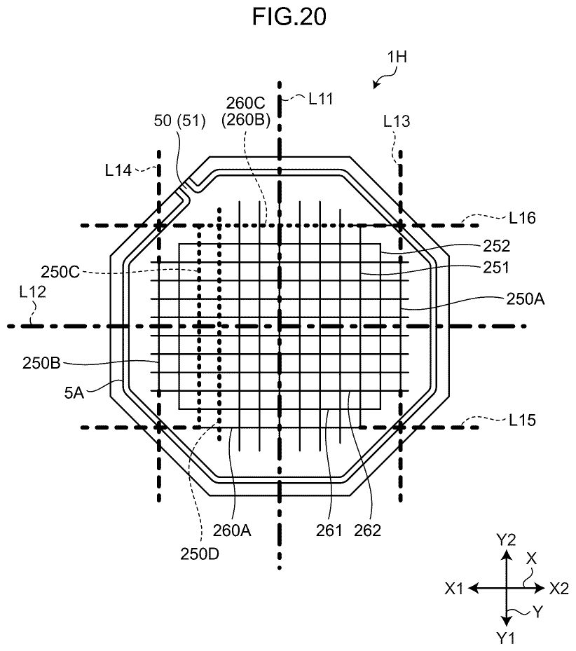

A light adjustment device according to a second embodiment will be described below. FIG. 12 is a schematic diagram of the light adjustment device according to the second embodiment when viewed from the upper side. FIG. 13 is a schematic diagram illustrating the uppermost light adjustment panel in a panel unit according to the second embodiment. FIG. 14 is a schematic diagram of a lower substrate included in the light adjustment panel in FIG. 13 when viewed from the upper side. FIG. 15 is a schematic diagram of an upper substrate included in the light adjustment panel in FIG. 13 when viewed from the upper side. FIG. 16 is a schematic diagram illustrating a state in which the lower substrate in FIG. 14 and the upper substrate in FIG. 15 are overlaid. FIG. 17 is a schematic diagram illustrating the uppermost light adjustment panel in the panel unit according to the second embodiment. FIG. 18 is a schematic diagram illustrating the second uppermost light adjustment panel in the panel unit according to the second embodiment. FIG. 19 is a schematic diagram illustrating the third uppermost light adjustment panel in the panel unit according to the second embodiment. FIG. 20 is a schematic diagram illustrating the fourth uppermost light adjustment panel in the panel unit according to the second embodiment.

Although the first embodiment describes the configuration in which the shapes of the panel unit and each light adjustment panel are quadrangular, the second embodiment describes a configuration in which the shapes of the panel unit and each light adjustment panel are octagonal.

A light adjustment device 100B according to the second embodiment includes a panel unit 110B. As illustrated in FIG. 12, the shape of the panel unit 110B is a regular octagon when viewed in the Z direction. The panel unit 110B is formed by stacking four light adjustment panels 1E, 1F, 1G, and 1H in the Z direction (first direction). Specifically, the four light adjustment panels are, sequentially from the upper side, the light adjustment panel 1E, the light adjustment panel 1F, the light adjustment panel 1G, and the light adjustment panel 1H.

As illustrated in FIG. 12, a circle B100 illustrated with a dashed and double-dotted line is the boundary between a light-shielding region (frame region) A20 and a light-transmitting region (effective region) B20. The inside of the circle B100 is the light-transmitting region B20, and the outside of the circle B100 is the light-shielding region A20. The circle B100 coincides with inner edges 341a and 342a of plane electrodes 341 and 342 to be described later. As illustrated in FIG. 13, end portions 21, 22, and 23 are provided in the light adjustment panel 1E. A first terminal group 10 is provided at the end portion 21, and a second terminal group 20 is provided at the end portion 23. A first sealing material 5A is provided outside the circle B100. The first sealing material 5A continuously extends from a bent portion 55 at one end to a bent portion 56 at the other end, and a gap 51 between the one end and the other end serves as an injection port 50. The light adjustment panel 1E includes a lower substrate 2E and an upper substrate 3E.

As illustrated in FIGS. 14 and 16, the lower substrate 2E has sides 211, 212, 213, 214, 215, 216, 217, and 218.

Wiring, liquid crystal drive electrodes, and coupling portions are provided on the lower substrate 2E. A coupling portion C1 of the lower substrate 2E and a coupling portion C3 of the upper substrate 3E (refer to FIG. 15) are electrically coupled to each other through a conductive pillar (not illustrated) that is capable of conduction. Similarly, a coupling portion C2 of the lower substrate 2E and a coupling portion C4 of the upper substrate 3E (refer to FIG. 15) are electrically coupled to each other through a conductive pillar (not illustrated) that is capable of conduction.

The first terminal 101 and the fifth terminal 201 are electrically coupled to each other through a wiring line 241. The wiring line 241 is coupled to the coupling portion C1.

The second terminal 102 and the sixth terminal 202 are electrically coupled to each other through wiring lines 243 and 245. The wiring line 243 is coupled to a wiring line 246. The wiring line 246 extends up to a distal end 247. The third terminal 103 and the seventh terminal 203 are electrically coupled to each other through a wiring line 248. The fourth terminal 104 and the eighth terminal 204 are electrically coupled to each other through a wiring line 249. The wiring line 249 is coupled to the coupling portion C2.

A plurality of first drive electrodes 250 are provided on the lower substrate 2E. Among the first drive electrodes 250, an electrode positioned at the farthest end on the Y1 side is a first drive electrode 250A, and an electrode positioned at the farthest end on the Y2 side is a first drive electrode 250B.

A straight line positioned at the center between the first drive electrode 250A and the first drive electrode 250B is defined as a first straight line L11. Specifically, the first straight line L11 extends in the X direction. The distance between the first straight line L11 and the first drive electrode 250B is equal to the distance between the first straight line L11 and the first drive electrode 250A. The first drive electrodes 250 include first drive electrodes 251 and 252. The first drive electrodes 251 are coupled to the wiring lines 243 and 246. The first drive electrodes 252 are coupled to the wiring line 249. The first drive electrodes 251 and 252 extend in the X direction. The first drive electrodes 251 and 252 are alternately arranged in the Y direction. A straight line overlapping the first drive electrode 250A is defined as a third straight line L13, and a straight line overlapping the first drive electrode 250B is defined as a fourth straight line L14. The third straight line L13 and the fourth straight line L14 extend in the X direction.

As illustrated in FIGS. 15 and 16, the upper substrate 3E has sides 311, 312, 313, 314, 315, 316, 317, and 318. The two plane electrodes 341 and 342 are provided on the upper substrate 3E. The plane electrodes 341 and 342 are, for example, black metal patterns and have an effect of blocking the light 130. The plane electrode 341 is positioned on the Y1 side, and the plane electrode 342 is positioned on the Y2 side. The outer perimeters of the plane electrodes 341 and 342 are substantially octagonal.

A plurality of second drive electrodes 260 are provided on the upper substrate 3E. Among the second drive electrodes 260, an electrode positioned at the farthest end on the X1 side is a second drive electrode 260A, and an electrode positioned at the farthest end on the X2 side is a second drive electrode 260B.

A straight line positioned at the center between the second drive electrode 260A and the second drive electrode 260B is defined as a second straight line L12. Specifically, the second straight line L12 extends in the Y direction. The distance between the second straight line L12 and the second drive electrode 260A is equal to the distance between the second straight line L12 and the second drive electrode 260B. The second drive electrodes 260 include second drive electrodes 261 and 262. The second drive electrodes 261 are coupled to the plane electrode 341. The second drive electrodes 262 are coupled to the plane electrode 342. The second drive electrodes 261 and 262 extend in the Y direction. The second drive electrodes 261 and 262 are alternately arranged in the X direction. A straight line overlapping the second drive electrode 260A is defined as a fifth straight line L15, and a straight line overlapping the second drive electrode 260B is defined as a sixth straight line L16. The fifth straight line L15 and the sixth straight line L16 extend in the Y direction.

The inner edge 341a of the plane electrode 341 and the inner edge 342a of the plane electrode 342 extend along the circle B100 (refer to FIG. 13) centered at an intersection point of the first straight line L11 and the second straight line L12. Thus, the inside of the inner edges 341a and 342a is the light-transmitting region (effective region) B20, and the outside of the inner edges 341a and 342a is the light-shielding region (frame region) A20. The coupling portion C3 is coupled to the plane electrode 341, and the coupling portion C4 is coupled to the plane electrode 342.

The four light adjustment panels 1E, 1F, 1G, and 1H included in the panel unit 110B will be sequentially described below. As illustrated in FIG. 17, the injection port 50 in the light adjustment panel 1E faces a mid-point between the X2 side and the Y2 side. As illustrated in FIG. 18, the light adjustment panel 1F is in a state obtained by rotating the light adjustment panel 1E 180° about the intersection point of the first straight line L11 and the second straight line L12. As illustrated in FIG. 19, the light adjustment panel 1G is in a state obtained by rotating the light adjustment panel 1E clockwise by 90° about the intersection point of the first straight line L11 and the second straight line L12. As illustrated in FIG. 20, the light adjustment panel 1H is in a state obtained by rotating the light adjustment panel 1G by 180° about the intersection point of the first straight line L11 and the second straight line L12.

As illustrated in FIG. 17, in the light adjustment panel 1E, among the first drive electrodes 250, drive electrodes that are most likely to become open-circuited due to a high-load test are first drive electrodes 250C and 250D disposed at positions closest to the injection port 50. The first drive electrodes 250C and 250D are illustrated with bold dashed lines. Among the second drive electrodes 260, a drive electrode that is most likely to become open-circuited due to a high-load test is a second drive electrode 260C disposed at a position closest to the injection port 50. The second drive electrode 260C is illustrated with a bold dashed line. In the second embodiment, the second drive electrode 260C is identical to the second drive electrode 260B.

In the second embodiment as well, even if a second drive electrode of one light adjustment panel becomes open-circuited, drive electrodes of the other three light adjustment panels that overlap the second drive electrode of the one light adjustment panel as viewed in the Z direction remain in a closed-circuit state. For example, the second drive electrode 260A of the light adjustment panel 1F illustrated in FIG. 18, the first drive electrode 250B of the light adjustment panel 1G illustrated in FIG. 19, and the first drive electrode 250A of the light adjustment panel 1H illustrated in FIG. 20 are disposed on the lower side relative to the second drive electrode 260C of the light adjustment panel 1E illustrated in FIG. 17 in the Z direction so as to overlap the second drive electrode 260C of the light adjustment panel 1E.

As described above, the second embodiment has the same effects as the first embodiment. Specifically, in the present embodiment, the gap 51 of the first sealing material 5 does not overlap the first straight line L11 or the second straight line L12. Thus, if two first drive electrodes 250 of one light adjustment panel 1 become open-circuited, drive electrodes in an open-circuited state are not concentrated in a specific portion even in the configuration in which the four light adjustment panels are stacked. Consequently, darkening of part of the light-transmitting region of a light adjustment device 100B is inhibited.

The panel unit 110B and the light adjustment panel 1E each have an octagonal perimeter when viewed in the Z direction. In this case as well, the light adjustment panels 1E, 1F, 1G, and 1H are octagonal; and thus, when the light adjustment panels 1 are rotated by 90° or 180° and stacked, it is only necessary to align the sides of the respective light adjustment panels with each other when viewed in the Z direction, which facilitates stacking work.

What is claimed is:

1. A light adjustment device comprising a panel unit in which a plurality of light adjustment panels are stacked in a first direction, wherein
the light adjustment panels each comprise
a lower substrate provided with a plurality of first drive electrodes,
an upper substrate overlapping the lower substrate as viewed in the first direction and provided with a plurality of second drive electrodes,
a liquid crystal layer positioned between the lower substrate and the upper substrate,
a first sealing material extending along a perimeter of the liquid crystal layer between the lower substrate and the upper substrate and provided with an injection port, and
a second sealing material sealing the injection port,
the first sealing material continuously extends from one end to the other end, and a gap between the one end and the other end serves as the injection port,
the first drive electrodes each extend in a second direction intersecting the first direction and are disposed at intervals in a third direction intersecting the first direction and the second direction,
the second drive electrodes each extend in the third direction and are disposed at intervals in the second direction,
a straight line extending in the second direction and positioned at a center in the third direction between a first drive electrode positioned at an end on one side in the third direction among the first drive electrodes and a first drive electrode positioned at an end on the other side in the third direction is defined as a first straight line,
a straight line extending in the third direction and positioned at a center in the second direction between a second drive electrode positioned at an end on one side in the second direction among the second drive electrodes and a second drive electrode positioned at an end on the other side in the second direction is defined as a second straight line, and
when viewed in the first direction, the gap of the first sealing material does not overlap the first straight line or the second straight line.

2. The light adjustment device according to claim 1, wherein
a straight line extending in the second direction and overlapping a first drive electrode positioned at an end on one side in the third direction among the first drive electrodes is defined as a third straight line,
a straight line extending in the second direction and overlapping a first drive electrode positioned at an end on the other side in the third direction among the first drive electrodes is defined as a fourth straight line, and
when viewed in the first direction, the gap of the first sealing material is provided at a position between the third straight line and the fourth straight line and not overlapping the third straight line or the fourth straight line.

3. The light adjustment device according to claim 1, wherein
a straight line extending in the third direction and overlapping a second drive electrode positioned at an end on one side in the second direction among the second drive electrodes is defined as a fifth straight line,
a straight line extending in the third direction and overlapping a second drive electrode positioned at an end on the other side in the second direction among the second drive electrodes is defined as a sixth straight line, and
when viewed in the first direction, the gap of the first sealing material is provided at a position between the fifth straight line and the sixth straight line and not overlapping the fifth straight line or the sixth straight line.

4. The light adjustment device according to claim 3, wherein the panel unit and the light adjustment panels each have a polygonal perimeter when viewed in the first direction.

5. The light adjustment device according to claim 4, wherein the panel unit and the light adjustment panels each have a quadrangular perimeter when viewed in the first direction.

6. The light adjustment device according to claim 4, wherein the panel unit and the light adjustment panels each have an octagonal perimeter when viewed in the first direction.
